(19) United States
(12) Patent Application Publication
(10) Pub. No.: US 2006/0054227 A1
(43) Pub. Date: Mar. 16, 2006

(54) Fluid rotating apparatus using EHD technology

(75) Inventor: Dong-kee Sohn, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/153,326

(22) Filed: Jun. 16, 2005

(30) Foreign Application Priority Data
Sep. 10, 2004 (KR) 2004-72547

(51) Int. Cl. F15C 1/00; F15C 1/04

(52) U.S. Cl. 137/831; 137/803

(57) ABSTRACT

A fluid rotating apparatus employing micro electro-mechanical system (MEMS) technology and electrohydrodynamic (EHD) technology, including a basal layer having a space for drawing therein a polar-fluid; a plurality of first and second electrodes mounted in the space; a cover sealing the space and including an inlet for supplying the polar-fluid to the space and an outlet for discharging the polar-fluid received in the space; a third electrode mounted to the cover; and a power device for supplying electric power to the first to the third electrodes.

### CROSS-REFERENCE TO RELATED APPLICATIONS

This application claims the benefit of Korean Patent Application No. 2004-72547, filed Sep. 10, 2004, in the Korean Intellectual Property Office, the disclosure of which is incorporated herein by reference.

### BACKGROUND OF THE INVENTION

1. Field of the Invention

The present invention relates to a fluid rotating apparatus. More particularly, the present invention relates to a microfluidic rotating apparatus implemented by applying micro electro-mechanical system (MEMS) technology to electrohydrodynamic (EHD) technology.

2. Description of the Related Art

Micro electro-mechanical system (MEMS) refers to a technology for processing a micromachine structure using a semiconductor processing method, or to the processed products thus obtained. Using MEMS technology, machines and devices having a microstructure on the order of less than micrometers (μm) can be designed. Therefore, MEMS technology is supported worldwide as a strategic industry due to its innovative prospects in a broad range of industries such as the electronics, machinery, medical and defense industries.

When MEMS technology is combined with electrohydrodynamic (EHD) technology, a fluid rotating apparatus of miniature size can be implemented. Generally, EHD technology enables moving of a dielectric liquid (for example, a polar-fluid such as brine) without requiring a dynamic part. In case of fabricating, using EHD technology, a pump or a liquid-rotating apparatus for moving the dielectric liquid, a pressure difference, which is a motive power for moving the dielectric liquid, can be obtained from an electric field in the dielectric liquid and an electric field loaded to the environment. A fluid rotating apparatus employing MEMS process and EHD technology affords a long lifespan since it does not require a dynamic part for moving the dielectric liquid, and operates even on very small sample volumes. Therefore, such fluid rotating apparatuses are being actively investigated.

### SUMMARY OF THE INVENTION

It is therefore an object of the present invention to provide a fluid rotating apparatus, implemented by combining micro electro-mechanical system (MEMS) technology with electrohydrodynamic (EHD) technology, capable of centrifuging a micro particle in very small sample volumes at the biological cell level without causing any damage to the particle, and providing a long lifespan.

In order to achieve the above-described objects, the present invention provides a fluid rotating apparatus comprising a basal layer including a space for drawing therein a polar-fluid; a plurality of first and second electrodes mounted in the space; a cover sealing the space and comprising an inlet for supplying the polar-fluid to the space and an outlet for discharging the polar-fluid received in the space; a third electrode mounted on the cover; and a power device for supplying electric power to the first to the third electrodes.

Preferred aspects of the invention are described below.

The first to the third electrodes have a plate form and are radially arranged so as not to overlap with one another.

The power device supplies a three-phase alternating current (AC) power source having different phases.

The basal layer is made of silicon.

Another aspect of the present invention provides a fluid rotating apparatus comprising a basal layer including a space for drawing therein a polar-fluid; a plurality of first to third electrodes disposed in the space; a cover sealing the space and comprising an inlet for supplying the polar-fluid to the space and an outlet for discharging the polar-fluid received in the space; and a power device for supplying electric power to the first to the third electrodes.

In this embodiment, the structures of the first through the third electrodes and the basal layer can be the same as those of the first embodiment.

A fluid rotating apparatus according to a third embodiment of the present invention comprises a basal layer; a plurality of first to third electrodes mounted to the basal layer; a cover disposed above the basal layer and comprising a space for drawing therein a polar-fluid, an inlet for supplying the polar-fluid to the space and an outlet for discharging the polar-fluid received in the space; and a power device for supplying electric power to the first to the third electrodes.

According to certain aspects and embodiments of the present invention as described above, the lifespan of the apparatus can be elongated due to the absence of a dynamic structure for rotating the polar-fluid. Also, when the fluid rotating apparatus is used as a centrifuge, micro particles in a small amount of sample at the cell level can be centrifuged without being damaged. In addition, the fluid rotating apparatus according to the present invention can be used as a fluid pump by connecting a dedicated induction pipe to an inlet and an outlet, and further used as a motive power for a micromachine utilizing a pressure of the fluid discharged through the outlet.

### BRIEF DESCRIPTION OF THE DRAWINGS

The above aspect and other features of the present invention will become more apparent by describing in detail exemplary embodiments thereof with reference to the attached drawings in which:

FIG. 1 is a plan view of a fluid rotating apparatus according to an embodiment of the present invention;

FIG. 2 is a sectional view of FIG. 1 cut along line II-II;

FIG. 3 is an exploded perspective view of a fluid rotating apparatus according to the first embodiment of the present invention;

FIG. 4 is an exploded perspective view of a fluid rotating apparatus according to a second embodiment of the present invention; and

FIG. 5 is a plan view of a fluid rotating apparatus according to a third embodiment of the present invention, showing first to third electrodes disposed on a coplanar surface.

### DETAILED DESCRIPTION OF THE PREFERRED EMBODIMENTS

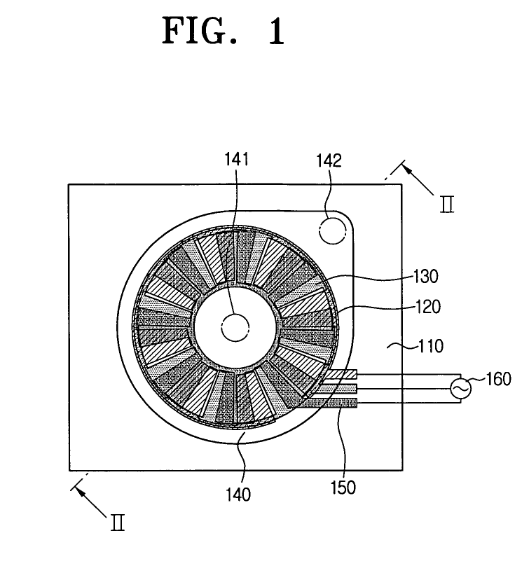

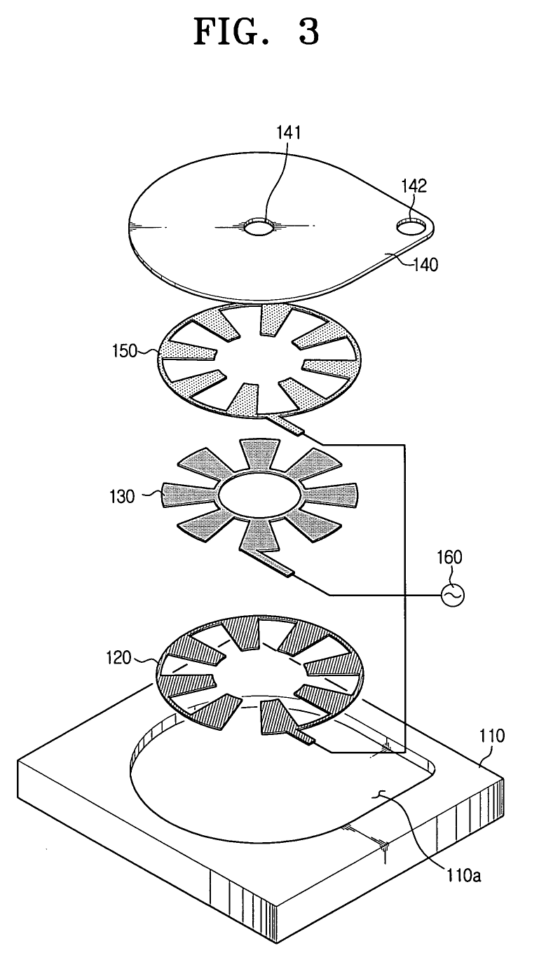

Hereinafter, a first embodiment of the present invention will be described in detail with reference to FIGS. 1 to 3.

The detailed description below is provided to assist in a comprehensive understanding of the invention. Thus, it is apparent that the present invention can be carried out without being limited to such structure. Also, well-known functions or constructions are not described in detail since they would obscure the invention in unnecessary detail.

As shown in FIGS. 1 through 3, a fluid rotating apparatus employing electrohydrodynamic (EHD) technology comprises a basal layer 110, first and second electrodes 120 and 130, a cover 140, a third electrode 150, and a power device 160.

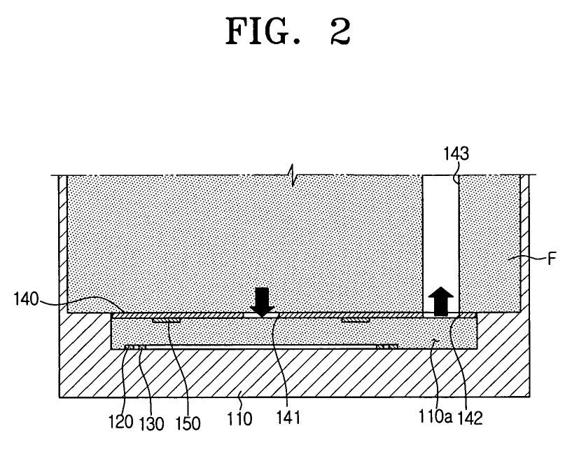

A polar-fluid F (FIG. 2), for example, brine is disposed on the basal layer 110, and a space 110a for drawing in the polar-fluid F is formed. The basal layer 110 is preferably made of silicon. Preferably, a diameter of the space 110a is no more than approximately 2 mm. A height of the space 110a may be approximately 0.1 mm.

A plurality of the first and the second electrodes 120 and 130 are alternately disposed in the space 110a so as not to overlap with each other.

The cover 140 seals the space 110a and comprises an inlet 141 and an outlet 142. The polar-fluid F disposed on the basal layer 110 is drawn into the space 110a through the inlet 141, and the drawn-in polar-fluid F is discharged to an upper part of the basal layer 110 through the outlet 142. The outlet 142 may include an induction pipe 143 for inducing the discharged polar-fluid F.

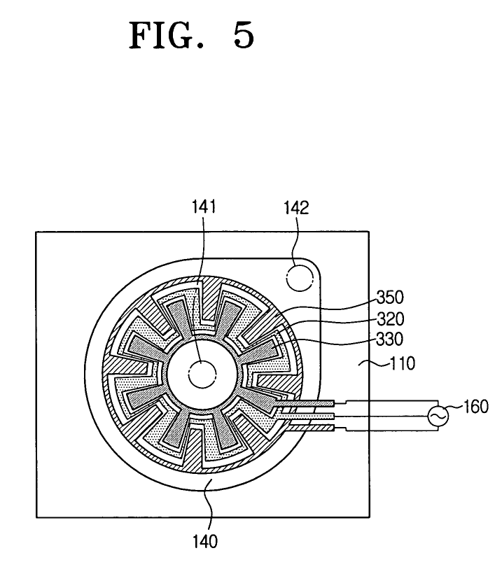

The third electrode 150 is disposed on the basal layer 110 or the cover 140 to face the first and the second electrodes 120 and 130. A plurality of the third electrodes 150 are inwardly protruded on an annular body so as not to overlap with the first and the second electrodes 120 and 130. When the third electrode 150 is mounted on the cover 140, the third electrode 150 having a similar structure as that of the first electrode 120 may partly overlap with the first and the second electrodes 120 and 130, as shown in FIGS. 1 through 4. As shown in FIG. 5 according to another embodiment of the present invention, all of first to third electrodes 320, 330 and 350 may be mounted on the basal layer 110.

The power device 160 may be implemented by a three-phase alternating current (AC) power source for supplying three alternating voltages, typically having the same frequency, to the first to third electrodes 120, 130 and 150, respectively. The alternating voltages have a phase offset from each other, typically by 120°.

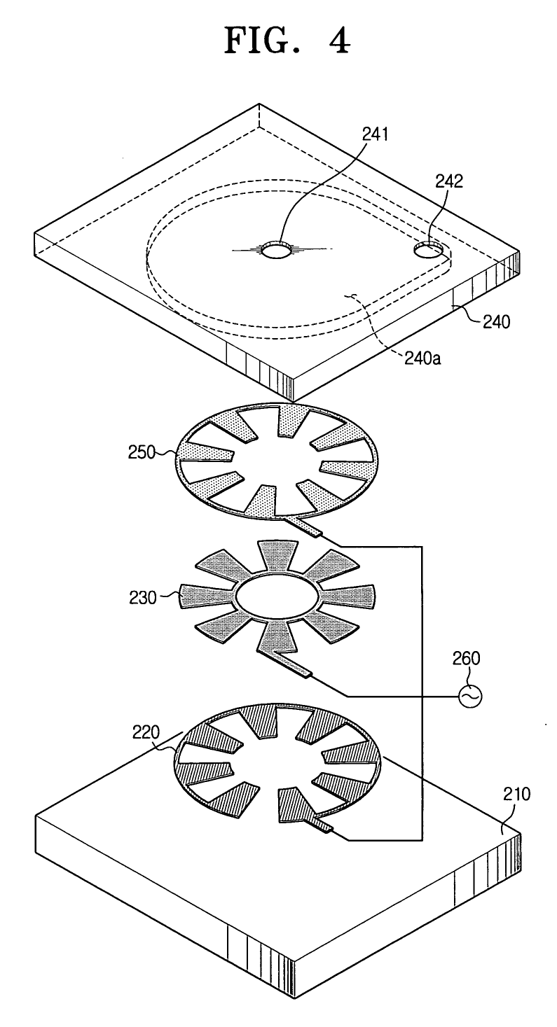

A fluid rotating apparatus employing EHD technology, according to another embodiment of the present invention, comprises a basal layer 210, first and second electrodes 220 and 230, a cover 240, a third electrode 250 and a power device 260, as shown in FIG. 4.

A polar-fluid F (FIG. 2) such as brine is disposed on the basal layer 210. The basal layer 210 is preferably made of silicon.

As shown in FIG. 4, a plurality of the first and the second electrodes 220 and 230 are alternately disposed on the basal layer 210 so as not to overlap with each other.

The cover 240 formed above the basal layer 210 comprises a space 240a for drawing therein the polar-fluid F, an inlet 241 for drawing the polar-fluid F into the space 240a and an outlet 242 for discharging the polar-fluid F received in the space 240a. The polar-fluid F disposed on the basal layer 210 is drawn into the space 240a through the inlet 241, and the drawn-in polar-fluid F is discharged to the upper part of the basal layer 210 through the outlet 242.

The third electrode 250 is disposed on the cover 240 to face the first and the second electrodes 220 and 230. Here, a plurality of the third electrodes 250 are inwardly protruded on an annular body so as not to overlap with the first and the second electrodes 220 and 230.

The power device 260 may be implemented by a three-phase alternating current (AC) power source for supplying alternating voltages of offset phase to the first to the third electrodes 220, 230 and 250, respectively.

A fluid rotating apparatus using EHD technology according to a third embodiment of the present invention has the same structure as the first embodiment described above, but differs in that the plurality of first to third electrodes 320, 330 and 350 are alternately mounted on the basal layer 110.

The first to the third electrodes of the first to the third embodiments of the present invention are preferably formed as a flat board. This is because, if the first to the third electrodes have a projection form, the electric field concentrated on such projected electrodes can interfere with rotation of the polar-fluid F.

Hereinbelow, operation of the fluid rotating apparatus according to an embodiment of the present invention will be described with reference to the accompanying drawings. While the space 110a is formed in the basal layer 110 in a first embodiment, the space 240a of the second embodiment is formed at the cover 240. Also, the third embodiment has a similar structure as the first embodiment except that the first through the third electrodes 320, 330 and 350 are formed on the basal layer 110. Therefore, the first embodiment will be referred to in the following description.

When the three-phase AC power source supplies alternating voltages of offset phase to the first to the third electrodes 120, 130 and 150, respectively, through the power device 160, the polar-fluid F received in the space 110a is rotated within the space 110a by a Coulomb force generated due to the phase differences at the first to the third electrodes 120, 130 and 150. As the polar-fluid F starts rotating, pressure outside the space 110a increases and pressure at the center decreases due to centrifugal force. Therefore, the polar-fluid F disposed at the upper part of the basal layer 110 is drawn into the space 110a through the inlet 141 because of the pressure difference. Being pushed by the drawn-in polar-fluid F, the polar-fluid F, which was already in the space 110a, is discharged to the outside of the space 110 through the outlet 142 in an amount as much as the amount of polar-fluid F drawn in through the inlet 141.

According to the above construction, a dynamic structure for supplying a rotating force to the polar-fluid F is not required, thereby avoiding damage by abrasion and elongating the lifespan of the apparatus. Furthermore, although approximately 5˜20 kV of high voltage is necessary for operation, the required electric current is only about 10 μA.

The fluid rotating apparatus configured as above can also be used as a centrifuge for centrifugally separating material of a cell unit. In this case, a heater (not shown) is provided at the upper part of the basal layer 110 to separate connected cells of various sizes, included in the polar-fluid F, and the three-phase AC power source is supplied through the power device 160 to the first to the third electrodes 120, 130 and 150. Therefore, the polar-fluid F disposed in the space 110a rotates at high speed and draws in the polar-fluid F including cells of various sizes through the inlet 141. The drawn-in polar-fluid F is discharged to the outside of the space 110a through the outlet 142 while the cells in the polar-fluid F are separated according to their respective weights. As shown in FIG. 2, an induction pipe 143 may be provided to facilitate capture of the cells discharged therethrough.

Additionally, the fluid rotating apparatus having the above structure can be applied as a fluid pump by forming the inlet 141 and the outlet 142 as separate induction pipes. Also, the fluid rotating apparatus is applicable as a motive power for a micromachine.

As can be appreciated from the above description, the fluid rotating apparatus according to the various embodiments of the present invention does not require a dynamic structure for rotating the polar-fluid F, thereby improving the lifespan of the apparatus. Also, since the polar-fluid F can be miniaturized using MEMS technology, micro particles in a small amount of sample at the cell level can be centrifuged.

In addition, the fluid rotating apparatus according to the various embodiments of the present invention can be applied as a fluid pump by providing dedicated induction pipes to the inlet 141 and the outlet 142, and as a motive power for a micromachine using the pressure of discharged fluid.

While the invention has been shown and described with reference to certain embodiments thereof, it will be understood by those skilled in the art that various changes in form and detail may be made therein without departing from the spirit and scope of the invention as defined by the appended claims.

What is claimed is:

1. A fluid rotating apparatus comprising:
a basal layer including a space for drawing therein a polar-fluid;
a plurality of first and second electrodes mounted in the space;
a cover sealing the space and comprising an inlet for supplying the polar-fluid to the space and an outlet for discharging the polar-fluid received in the space;
a third electrode mounted to the cover; and
a power device for supplying electric power to the first to the third electrodes.

2. The fluid rotating apparatus of claim 1, wherein the first to the third electrodes have a plate form and are radially arranged so as not to overlap with one another.

3. The fluid rotating apparatus of claim 1, wherein the power device is a three-phase alternating current (AC) power source for supplying alternating current offset in phase to each of the first to third electrodes, respectively.

4. The fluid rotating apparatus of claim 1, wherein the basal layer is made of silicon.

5. A fluid rotating apparatus comprising:
a basal layer including a space for drawing therein a polar-fluid;
a plurality of first to third electrodes disposed in the space;
a cover sealing the space and comprising an inlet for supplying the polar-fluid to the space and an outlet for discharging the polar-fluid received in the space; and
a power device for supplying electric power to the first to the third electrodes.

6. A fluid rotating apparatus comprising:
a basal layer;
a plurality of first and second electrodes mounted to the basal layer;
a cover disposed above the basal layer and comprising a space for drawing therein a polar-fluid, an inlet for supplying the polar-fluid to the space and an outlet for discharging the polar-fluid received in the space;
a third electrode mounted to the cover; and
a power device for supplying electric power to the first to the third electrodes.

7. The fluid rotating apparatus of claim 6, wherein the first to the third electrodes have a plate form and are radially arranged so as not to overlap with one another.

8. The fluid rotating apparatus of claim 6, wherein the power device is a three-phase alternating current (AC) power source for supplying alternating current offset in phase to each of the first to third electrodes, respectively.

9. The fluid rotating apparatus of claim 6, wherein the basal layer is made of silicon.

10. A fluid rotating apparatus comprising:
a basal layer;
a plurality of first to third electrodes mounted to the basal layer;
a cover disposed above the basal layer and comprising a space for drawing therein a polar-fluid, an inlet for supplying the polar-fluid to the space and an outlet for discharging the polar-fluid received in the space; and
a power device for supplying electric power to the first to the third electrodes.
